(19) United States
(12) Patent Application Publication
(10) Pub. No.: US 2025/0324988 A1
(43) Pub. Date: Oct. 23, 2025

(54) ENHANCED WASHING OF FOOD PRODUCTS

(71) Applicant: SMARTWASH SOLUTIONS, LLC, Salinas, CA (US)

(72) Inventors: Christopher Michael MCGINNIS, Salinas, CA (US); James M. BRENNAN, Pleasanton, CA (US); Eric Child WILHELMSEN, Milpitas, CA (US); Greg ROLSKY, Carmel Valley, CA (US)

(21) Appl. No.: 19/184,628

(22) Filed: Apr. 21, 2025

Related U.S. Application Data
(60) Provisional application No. 63/637,167, filed on Apr. 22, 2024.
(60) Provisional application No. 63/743,530, filed on Jan. 9, 2025.

(51) Int. Cl. A23B 2/788; A01N 59/16; A01P 1/00; A22C 21/00; A23B 2/00; A23B 2/792; A23B 4/24; A23B 4/26; A23B 7/157; A23B 7/158

(52) U.S. Cl. CPC A23B 2/788; A01N 59/16; A01P 1/00; A22C 21/0061; A23B 2/001; A23B 2/003; A23B 2/792; A23B 4/24; A23B 4/26; A23B 7/157; A23B 7/158

(57) ABSTRACT

Methods and apparatus for washing food products are provided. An example controller for controlling washing of a food product is generally configured to execute executable instructions to cause the controller to control generation of a silver ion solution in a wash stage, the generation including mixing components of the silver ion solution in the wash stage, and to control application of the silver ion solution to the food product in the wash stage. An example method of washing a food product generally includes generating a silver ion solution in a wash stage, the generating including mixing components of the silver ion solution in the wash stage, and applying the silver ion solution to the food product in the wash stage.

### CROSS-REFERENCE TO RELATED APPLICATIONS

The present application for patent claims the benefit of priority to U.S. Provisional Application No. 63/637,167, entitled “Enhanced Processing of Round Produce” and filed Apr. 22, 2024 and to U.S. Provisional Application No. 63/743,530, entitled “Enhanced Washing of Food Products” and filed Jan. 9, 2025, both of which are incorporated by reference herein in their entireties for all applicable purposes.

### TECHNICAL FIELD

The present disclosure relates to food processing and, more particularly, to washing a food product.

### BACKGROUND

It is desirable to wash many raw agricultural products as a first step towards those products becoming food. Two common approaches for washing agricultural products are using spray bars to spray a wash fluid on the agricultural products and submerging the agricultural products in dip tanks of wash fluid. These approaches may or may not involve the use of a sanitizer, such as chlorine or peroxyacetic acid. In many cases, even in instances where sanitizers are used, the washing causes little reduction in pathogen or bacterial load on the agricultural products. Efforts to achieve reduction have led some to recommend impractical treatments, such as exposing the agricultural products to scalding water at over 75° C. for times greater than 3 minutes or dipping the agricultural products in wash fluid having 1000 ppm chlorine for over 5 minutes.

Pathogen outbreaks have been associated with round produce, such as melons (including netted melons like cantaloupes), apples, peaches, onions, and tomatoes. Thus, currently available washing techniques for mitigating pathogen contamination are apparently insufficient. While some pathogen outbreaks may relate to poor execution of pathogen mitigation techniques, pathogen mitigation systems that reduce or remove the human factor may prevent pathogen contamination of food even when the pathogen mitigation techniques are poorly executed. It is therefore desirable to develop improved pathogen mitigation techniques for round produce.

### SUMMARY

The systems, methods, and apparatus of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages described herein.

Certain aspects of the present disclosure provide an apparatus for washing at least one item of round produce. The apparatus generally includes an applicator and an opaque shroud. The applicator is configured to apply a first wash treatment solution to an entire exterior surface of the at least one item of round produce. The opaque shroud is configured to prevent light from impinging on the at least one item of round produce and the first wash treatment solution.

Certain aspects of the present disclosure provide a method of washing at least one item of round produce. The method generally includes applying a first wash treatment solution to an entire exterior surface of the item of round produce in a first wash stage while preventing light from impinging on the item of round produce and the first wash treatment solution in the first wash stage.

Certain aspects of the present disclosure provide a system for washing at least one item of round produce. The system generally includes an applicator comprising a plurality of spray nozzles, wherein the plurality of spray nozzles are configured to apply a silver ion solution to an exterior surface of the at least one item of round produce; an opaque shroud enclosing the plurality of spray nozzles and configured to prevent light from impinging on the at least one item of round produce and the silver ion solution during the application of the silver ion solution; and a roller conveyor belt passing through an interior of the opaque shroud. The roller conveyor belt is configured to move the at least one item of round produce from an entrance of the opaque shroud to an exit of the opaque shroud, and the roller conveyor belt is configured to cause the at least one item of round produce to rotate at least twice while the at least one item of round produce moves from the entrance of the opaque shroud to the exit of the opaque shroud.

Certain aspects of the present disclosure are directed to a method of washing a food product. The method generally includes generating a silver ion solution in a wash stage, the generating including mixing components of the silver ion solution in the wash stage, and applying the silver ion solution to the food product in the wash stage.

Certain aspects of the present disclosure are directed to a method of washing a food product. The method generally includes generating a silver ion solution in a mixing stage, the generating comprising mixing components of the silver ion solution in the mixing stage, and applying the silver ion solution to the food product in a wash stage, wherein the wash stage is downstream of the mixing stage.

Certain aspects of the present disclosure are directed to a non-transitory computer-readable medium comprising executable instructions that when executed by a processing system, cause the processing system to perform operations for washing a food product. The operations generally include generating a silver ion solution in a wash stage, the generating including mixing components of the silver ion solution in the wash stage, and applying the silver ion solution to the food product in the wash stage.

Certain aspects of the present disclosure are directed to a non-transitory computer-readable medium comprising executable instructions that when executed by a processing system, cause the processing system to perform operations for washing a food product. The operations generally include generating a silver ion solution in a mixing stage, the generating comprising mixing components of the silver ion solution in the mixing stage, and applying the silver ion solution to the food product in a wash stage, wherein the wash stage is downstream of the mixing stage.

Certain aspects of the present disclosure are directed to a controller for controlling washing of a food product. The controller is generally configured to execute executable instructions to cause the controller to control generation of a silver ion solution in a wash stage, the generation including mixing components of the silver ion solution in the wash stage and to control application of the silver ion solution to the food product in the wash stage.

Certain aspects of the present disclosure are directed to a controller for controlling washing of a food product. The controller is generally configured to execute executable instructions to cause the controller to control generation of a silver ion solution in a mixing stage, the generation including mixing components of the silver ion solution in the mixing stage, and to control application of the silver ion solution to the food product in a wash stage, wherein the wash stage is downstream of the mixing stage.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIGS. 1A, 1B, 1C, and 1D are block diagrams showing example food wash systems, in which certain aspects of the present disclosure may be practiced.

FIG. 2 is a block diagram of a food processing system, in accordance with certain aspects of the present disclosure.

FIG. 3 is a block diagram of a wash treatment solution control system, in accordance with certain aspects of the present disclosure.

FIG. 4 is a block diagram of an example apparatus for washing round produce, in accordance with certain aspects of the present disclosure.

FIG. 5 is a flow diagram of example operations for washing round produce, in accordance with certain aspects of the present disclosure.

FIGS. 6 and 7 are flow diagrams of example operations for washing a food product, in accordance with certain aspects of the present disclosure.

To facilitate understanding, identical reference numerals have been used, where possible, to designate identical elements that are common to the figures. It is contemplated that elements described in one aspect may be beneficially utilized on other aspects without specific recitation.

### DETAILED DESCRIPTION

Aspects of the present disclosure provide apparatus, systems, and methods for washing a food product. For example, the food product may include fresh produce or meat (e.g., poultry). In some cases, the food product may include items of round produce, such as melons (including netted melons, such as cantaloupe), peaches, apples, tomatoes, and onions. As used herein, the term “round” may refer to generally spherical or generally ellipsoidal objects.

Sanitizing the exterior prior to sale of some commodity products can reduce the potential for cross-contamination from the outer layer of peeled product to the edible portion during peeling or cutting of the product. As an example, salmonella outbreaks due to cantaloupe consumption are often related to this type of cross-contamination. In addition, when the exterior of the product is consumed, sanitizing the exterior of the product can reduce the microbial load delivered to consumers. Similarly, sanitizing the exterior of raw agricultural products as part of the conversion of a raw agricultural commodity to a ready-to-eat (RTE) food adds to food safety.

Utilization of the apparatus, systems, and methods of the present disclosure yields a surprising level of microbial lethality on the exterior surface of items of round produce, particularly for cantaloupe, whose woven surface has proven exceedingly difficult to sanitize sufficiently. For many items of round produce, including apples, peaches, tomatoes, onions, and cantaloupe, treatment with the disclosed apparatus, systems, and methods reduced multi-log inoculations to less than the normal detection limits with treatment times of as little as 30 seconds. These results were unexpected, given the years of research and challenges associated with sanitizing many of these products. The application of certain aspects of the present disclosure to food products that are less challenging may be justified by economies of scale the aspects allow.

The disclosed methods include treatment of the entire surface of the items of round produce and singulation of the items of round produce. Treatment of the entire surface of the items of round produce can be achieved by dipping, which is suitable for small-scale applications. However, spraying can be almost as effective, when done properly. For commercial applications, an example approach uses a roller belt with sprayers for treatment. A roller belt may cause the produce to roll to achieve complete coverage (e.g., treatment of the entire surface).

Singulation involves ensuring a single layer of round produce traverses the food washing system (e.g., on the roller belt) and that each item of round produce is prevented from touching another item of round produce, at least during the washing. Singulation ensures that the entire surface of each item of round produce receives treatment in both large commercial operations (e.g., roller belt with sprayers) and smaller operations using simple dipping. It is desirable for each of the items of round produce to be separated from other items sufficiently to allow treatment of the entire surface. Thus, it is desirable to avoid overloading the treatment system. When using a roller conveyor belt, it is desirable for product to be in a single layer and separated enough from each other to allow for the items of round produce to roll during transit down the roller conveyor belt. In certain aspects of the present disclosure, singulation of the infed items of round produce can be controlled by manually loading and distributing the round produce in a single layer, feed ramps that force the product to self-produce the single layer (e.g., tilted tables with a 30 to 90° turn), physical restrictions (e.g., size of entrance to a wash stage, overhead knock-down bars, fingers/dividers, etc.) in the feed assembly, and the like. The choice of technique(s) may be determined by the produce type, space, and/or the end user. In some aspects, singulation can be verified, for example, by camera.

It is desirable for the roller conveyor belt to have a length sufficient to allow for at least two complete rotations of each item of round produce within the treatment system. It may be also be desirable for each item of round produce to be exposed to a wash treatment solution for at least 30 seconds of residence time to ensure complete coverage and sufficient sanitizing treatment. In practice, a roller conveyor belt length of 5 to 10 feet (1.5 to 3 meters) may be sufficient. This length may depend on the size (e.g., the diameter) of the round produce and on whether a step to quench the wash treatment solution is included in a wash stage using the roller conveyor belt.

In certain aspects of the present disclosure, the wash treatment solution may be showered or misted onto the product. The reduction of pathogen load is influenced by the number of nozzles and the flow of the wash treatment solution to a minor extent. Increasing the flow beyond a certain flow rate (e.g., 0.5 gallons/minute (1.89 liters/minute) for maximum capacity of the roller belt with a single layer of product that is able to roll) may have diminishing returns.

In an example manual dipping mode, 15 gallons (56.78 liters) of the wash treatment solution can treat as many as 40 cantaloupes. Manual dipping may involve too much labor for most fresh cut operations.

It has been noted that the multi-layer nature of raw onions is effectively treated by dipping of the onions, allowing for more complete coverage of the multi-layer surface prior to peeling. Dipping appears to allow some penetration by the wash treatment solution into the edges of the interstitial space of the onions, where bacteria may reside. Peeled onions need not be dipped in this manner. A dip treatment can be effected in many ways including using an Archimedes screw conveyor or a simple dip tank with paddles. A dipping system may be operated with a control system, such as described in U.S. Pat. App. Pub. No. 2018/0093901 A1 to Brennan et al., entitled “System for Controlling Water Used for Industrial Food Processing” and filed Oct. 3, 2017, which is incorporated by reference herein in its entirety.

Previously known wash systems used for food processing have used chemical agents and/or mechanical agitation to enhance the effectiveness of the wash systems. The chemical agents may include sanitizers like chlorine and peroxy acids. Silver ions are a relatively new addition to the family of sanitizers used for processing food. Silver ions have been known to be antimicrobial for many years and have medical uses. The cost of silver and the tendency of silver ions to be reduced to much less active elemental silver have limited the usage of silver.

Recently, silver dihydrogen citrate, a stable solution, has changed some of the logistics of use. The solution may be shipped as a concentrate and diluted for use on-site in food-washing processes with significant microbial lethality. Silver is a precious metal and may be more costly to use than most other sanitizers. This prompts a desire to effectively use the silver and to recycle the silver to maximize usage and lower cost.

To recycle silver-ion-based sanitizers, it may be desirable to monitor and control the silver ions. Known assays include ion-selective electrodes, titrations, gravimetric assays (e.g., with chloride), atomic absorption, and ion-coupled plasma.

According to certain aspects of the present disclosure, a silver ion wash treatment solution described herein may be unstable and may most likely be replenished or replaced during operation of the systems described herein. The spray systems described herein may use recycled wash treatment solution, for example, if the wash treatment solution is reconditioned to avoid nozzle fouling.

In certain aspects of the present disclosure, the silver ion (Ag⁺) of the wash treatment solution is especially sensitive to light when in a mist or shower. This sensitivity may be mitigated, for example, by use of an opaque shroud (or other suitable cover) over the roller belt in the treatment area. The entrance(s) and/or exit(s) to the treatment area can be curtained off and still allow product to flow through the treatment area. It may be desirable to have access ports to allow visual confirmation of the misting/showering treatment within the treatment area, but it is desirable for these access ports to be closed during normal operation.

Silver ion is approved for food product sanitation by at least some government agencies, but current regulations mandate removal of silver ion for food treated therewith. This removal may be performed with a chlorinated rinse. In practice, a rinse with SmartWash SW™ (from SmartWash Solutions, LLC of Salinas, California) and chlorine is very effective and adds to the overall lethality of the treatment system. However, even a potable water rinse can be effective at silver ion removal.

There are numerous chemistry profiles that might be effective for the sanitizer treatment. Example chemistry profiles described herein include:
1) Treatment with silver ion solution followed by quenching with SmartWash SW™ with chlorine;
2) SmartWash SW™ with chlorine, followed by a transition treatment with lactic acid (about 2% by weight), then the silver ion solution, and finally potable water; and
3) Treatment with silver ion solution, followed by lactic acid and then SmartWash SW™ with chlorine.

There may be some benefit to treatment with lactic acid beyond this acid being a transition between the chlorine and silver solutions, but this small effect may be minor when compared to the overall benefits of the treatment. The preferred silver solutions are described in one or more of U.S. Pat. No. 10,939,697 to Brennan et al., issued Mar. 9, 2021; U.S. Pat. No. 11,528,930 to Brennan et al., issued Dec. 20, 2022; and U.S. Pat. No. 11,576,415 to Brennan et al., issued Feb. 14, 2023, which are all incorporated by reference herein in their entireties.

According to certain aspects of the present disclosure, the proper mixing of the silver ion solution can be verified by flow meters on the feeds for the various components. A flow meter can be placed on the infeed for each component into the blending system (e.g., a mixing stage). Specifically, silver dihydrogen citrate, SmartWash SWO™, and water infeed can be monitored to confirm a desired mixing ratio is being achieved. In other aspects, one monitor can be removed from an infeed and positioned to monitor the outfeed and the total flow to confirm that the proportions of the mixture are correct.

In certain aspects of the present disclosure, the silver concentration of the wash treatment system may be monitored as for the recirculated system.

According to certain aspects of the present disclosure, the pH of each of the various solutions can be monitored. In some cases, such monitoring with pH meters occurs prior to pressurization for pumping into and through the misting nozzles, as some pH meters can be damaged by pressurization, leading to errant readings.

In certain aspects of the present disclosure, monitoring the pH of the wash treatment solution may be used to confirm that the wash treatment solution has been properly blended to achieve the desired solution component ratio. This may also be useful when the intensity of the short-term wash treatment process should be adjusted, as taught in U.S. Pat. App. Pub. No. 2020/0229482 to McGinnis et al., entitled “Variable Intensity Controller for a Short-Term Intense Process” and filed Jan. 10, 2020, which is incorporated by reference herein in its entirety. Such measurement can also confirm that such adjustments have been completed properly.

In certain aspects of the present disclosure, the concentration of free active chlorine in the wash treatment solution may be monitored with a control system, which may include one or more processors/controllers. An example of such a control system is an Automated SmartWash Analytical Platform (ASAP)™ (from SmartWash Solutions, LLC of Salinas, California). Monitoring of the free active chlorine in the wash treatment solution is desirable for managing the chemistry of the quenching process. Monitoring of the free active chlorine may also permit recirculation of the quenching fluids.

According to certain aspects of the present disclosure, distribution of misting or showering nozzles within a wash stage can be verified and/or modified based on image or video captures by cameras.

According to certain aspects of the present disclosure, cameras may additionally or alternatively permit conservation of wash treatment solution by allowing detection of an absence of food product items or other changes, such as when the product type changes.

In certain aspects of the present disclosure, microbial lethality of the wash treatment process may be monitored by monitoring a reduction in indicator organisms. In some examples, measurement of such a reduction may be achieved within two hours.

Certain aspects of the present disclosure provide apparatus, systems, and methods for washing items of round produce. The provided methods include applying a first wash treatment solution to an entire exterior surface of the item of round produce in a first wash stage while preventing light from impinging on the item of round produce and the first wash treatment solution in the first wash stage. For example, cantaloupes may be conveyed through a silver ion mist under or within an opaque shroud.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure described herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

As shown and described herein, various features of the disclosure will be presented. Various aspects may have the same or similar features, and thus, the same or similar features may be labeled with the same reference numeral. Although similar reference numbers may be used in a generic sense, various aspects will be described and various features may include changes, alterations, modifications, etc. as would be appreciated by those of skill in the art, whether explicitly described or otherwise.

### Example Silver-Ion-Based Processes for Sanitizing Food

There may be two major considerations in controlling silver-ion-based processes for sanitizing. Monitoring the silver ion concentration and controlling the composition of the sanitizing solution may both be considered when using silver-ion-based sanitizing processes. Controlling the composition of the sanitizing solution may involve controlling the silver ion concentration, as well as other characteristics of the sanitizing solution.

Assays used in a laboratory may have issues when considered for use in a production environment that can be cold, wet, and generally unforgiving to equipment. In a production environment, it is desirable for the assay to provide the relevant information quickly and involve no complex manipulations or instrumentation. It is also desirable for the assay to be stable over time in order to avoid frequent recalibration. Furthermore, it is desirable for the assay to be sensitive across the range of interest for silver, which may be 5 to 100 parts per million (ppm).

In certain aspects of the present disclosure, a reductive assay of silver ions is provided that has the above-described desirable features.

Silver ions are readily reduced. As used herein, the term “reduction” generally refers to the gain of electrons by a chemical substance, so the reduction of silver ions may change the silver ions to elemental silver, for example. This reduction can be affected by light, which potentiates the oxidation of many components by the silver ions. Reduction of silver ions can also be affected chemically by a wide range of reductants. Suitable reductants for food processing sanitizing systems may include aldehydes, mercaptans, ascorbic acid, and erythorbic acid (and close kin of ascorbic acid and erythorbic acid). The action of these chemical reducing agents may be enhanced by alkali conditions. There are other reductants that could be used, although many alternatives are less compatible with most processing environments where silver ion sanitizing processes may be used.

According to certain aspects of the present disclosure, for an assay, a stream of the wash treatment solution (also referred to herein as the “process solution” or “sanitizing solution”) is treated to reduce the silver ions to make colloidal silver, which can be measured optically, for example, by absorbance, turbidity, or light scattering. The response from such optical procedures may be calibrated to convert the optical response to silver concentration. The measured concentration may be an absolute concentration in the wash treatment solution or a concentration that is relative (e.g., a relative concentration) to other components of the wash treatment solution.

In certain aspects of the present disclosure, determination of the concentration in any particular units during processing is not mandatory, as the objective of the process is to maintain control of the wash treatment solution. Deviations from the nominal operating conditions (e.g., lowering of the silver ion concentration or changes to the pH of the wash treatment solution) may call for corrections by the system (e.g., adding silver or adding one or more other components of the wash treatment solution), and control can be maintained with any suitable units for concentration.

In the case of the intense, short-term wash described in U.S. Pat. App. Pub. 2017/0156390 A1 to Brennan et al., entitled “Short-Term Wash Treatment of Produce” and filed Jul. 13, 2016, which is incorporated by reference herein in its entirety, the wash treatment solution is composed of an acidulant and polyol mixture in chlorine-free water with a metered amount of silver dihydrogen citrate. Mixing the wash treatment solution with approximately 30% by volume of sodium hydroxide (NaOH) (which may be referred to herein as a “second reagent”) in a concentration of 4% may adjust the pH of the wash treatment solution to allow about 0.1 grams of ascorbic acid (which may be referred to herein as a “first reagent”) to reduce the silver ions in the wash treatment solution, generating colloidal silver. The colloidal silver may then be optically measured. As an alternative to NaOH, potassium hydroxide (KOH) or other alkali can be used, as long as no insoluble silver salts are formed. This mass of ascorbic acid can readily be converted to a fluid flow by mixing with chlorine-free water. The relative volumes may be readily adjusted to various sizes of flow cells useful for measuring the silver in a sample stream. According to certain aspects of the present disclosure, a suitable mixture of wash treatment solution, alkali, and ascorbic acid may depend on the precise wash treatment solution, but the principle will be the same (e.g., adjust the pH of the wash treatment solution to a desired range, and add the reducing agent, or otherwise reduce the silver ions).

In certain aspects of the present disclosure, the wash treatment solution may be filtered prior to mixing with the alkali and acid in order to avoid product particles and other debris in the flow cell.

According to certain aspects of the present disclosure, the three fluids (wash treatment solution, alkali, and acid) may be mixed using Venturi mixing tubes, where the generated turbulence mixes the solutions.

In certain aspects of the present disclosure, the mixed and now reacted solution may be optically measured and then, in some cases, dumped to drain. The materials in the mixed and reacted solution are generally not considered hazardous.

In addition or as an alternative to reducing the silver ions using a chemical agent, the silver ions may be reduced using an optical means, such as a light source. For example, in certain aspects of the present disclosure, a sample stream of the sanitizing solution may flow through a coil wrapped around an intense light source to cause the reduction of the silver ions. For example, a mercury lamp may provide the desired ultraviolet (UV) light.

The usage of intense light to cause the reduction of the silver ions may be less preferred than the above chemical procedure, because the light intensity will typically decline slowly over time. At some point, the light intensity can be insufficient to reduce the silver ions in the wash treatment solution. Preventative maintenance may prevent failures of the light-based reduction of the silver over time.

The scale of the wash treatment solution flow through the optical system measuring the silver concentration may be dependent on the flow cell volume of the optical measuring system. In certain aspects of the present disclosure, it is desirable for the volume of the flow cell of the optical instrument to be replaced three to five times per minute to avoid aliasing of the measurements. If lowered time resolution is acceptable in a system, then the rate of replacement of the volume of the flow cell can be reduced. In certain aspects, the flow cell may be heated to avoid condensation from accumulating.

In certain aspects of the present disclosure, the optical density of the flow cell and the wavelength of light used in measuring the silver concentration may be selected to avoid interference from debris in the solution. In some examples, a wavelength scan of the reacted material may be performed over a suitable wavelength range. In other examples, the long wavelengths of visible light may be useful for measuring the silver concentration. In certain aspects, a fixed-wavelength opacity meter may be used to measure colloidal silver in the sample stream of the wash treatment solution. According to certain aspects of the present disclosure, the silver concentration may be controlled by measuring scattered light from the reacted material (e.g., at right angles).

According to certain aspects of the present disclosure, glass parts may be used for the flow cell and other parts of the system for assaying the silver in the wash treatment solution, because effluent from the assay is not returned to the process line. Thus, there is a minimal chance of broken glass from the flow cell and other parts of the system contaminating food in a food processing system using the disclosed techniques.

In certain aspects of the present disclosure, a control system may be included having three or more functions. A first function of the control system may be to maintain the silver ion concentration of the wash treatment solution, such that silver may be recycled in a food washing system. Maintenance of the silver ion concentration may be accomplished by adding concentrated silver ions to the wash treatment solution. The control system may control a metering pump to add a solution of concentrated silver ions to the wash treatment solution.

A second function of the control system may be to maintain a desired concentration of other constituents in the wash treatment solution and a total quantity of the wash treatment solution (e.g., a solution level (also referred to as a “water level”) of the wash treatment solution). Typically, controlling the concentration of the other constituents and the total quantity of the wash treatment solution may include adding an acidulant (e.g., an organic acid such as lactic acid, phosphoric acid, tartaric acid, or citric acid), a polyol (e.g., glycerin or propylene glycol), and/or chlorine-free water to a reservoir of the wash treatment solution. It is desirable for the acidulant, polyol, and water to be free of chlorine to avoid reaction with the silver ions.

A third function of the control system may be to control the pH of the wash treatment solution within a desired range. This range may be based on the tolerance of the product for the pH and the tolerance of the quantity of alkali added during assaying of the wash treatment solution. Controlling the pH may, for example, be accomplished by the control system controlling a metering pump to add a hydroxide-supplying solution (e.g., a sodium hydroxide or potassium hydroxide solution) to the wash treatment solution.

In certain aspects of the present disclosure, a digital control system may report various parameters (e.g., silver ion concentration and pH of the wash treatment solution) to a data storage function to have the data stored for control verification.

According to certain aspects of the present disclosure, a control system may include a touch screen or other interface enabling a user to adjust various set points of the control system and process incoming signals. The incoming signals may include silver concentration as either an analog signal or digital output from the optical device, a level in the wash treatment solution reservoir, and the pH of the wash treatment solution. The pH may be measured with a pH electrode compatible with the acid environment.

In certain aspects of the present disclosure, each of the reagents (e.g., ascorbic acid and sodium hydroxide) may be considered food safe and compatible with a food processing environment. That is, none of the reagents may be considered likely to contaminate food in a food processing environment or likely to facilitate microbial contamination of food or food processing equipment. In addition, the reagents described herein present only minor hazards when concentrated.

### Example Food Processing Systems

Certain aspects of the present disclosure may include a food processing system for washing food products. The food processing system may wash the food products using one or more wash stages. For example, each of the wash stages may include a wash tank, a wash flume (with or without an active wash area), a rotating drum washer, and/or an agitated tank where air or other mechanical agitation is used to promote cleaning. A wash stage may also include one or more sprayers (e.g., water curtains) configured to spray the food products with wash treatment solution, wash water of another type, and/or rinse water before and/or after the food products are washed in another wash stage.

The following description describes methods and systems for washing a food product using a short-term wash treatment and short-term wash device. A short-term wash treatment (which may also be called an “intense prewash treatment”) using a short-term wash solution and device, when combined with a wash treatment and device, synergistically enhances the lethality of traditional wash systems for ready-to-eat (RTE) produce and other food products. A short-term wash treatment permits the usage of materials that would otherwise potentially damage or otherwise prevent the sale of RTE produce and other food products. For example, an intense prewash with a phosphoric acid and propylene glycol solution or with a silver dihydrogen citrate solution has proven particularly effective when exposure times are controlled and limited. The short-term wash treatment may be adjusted according to a suitable time for treating the particular product, which is generally between 30 and 60 seconds. Longer treatments (i.e., longer intervals for applying the short-term wash solution) may be less practical given the product throughput and the potential for intense treatment solutions to shorten the shelf life of the product. The product may be, for example, fresh round produce, as described herein.

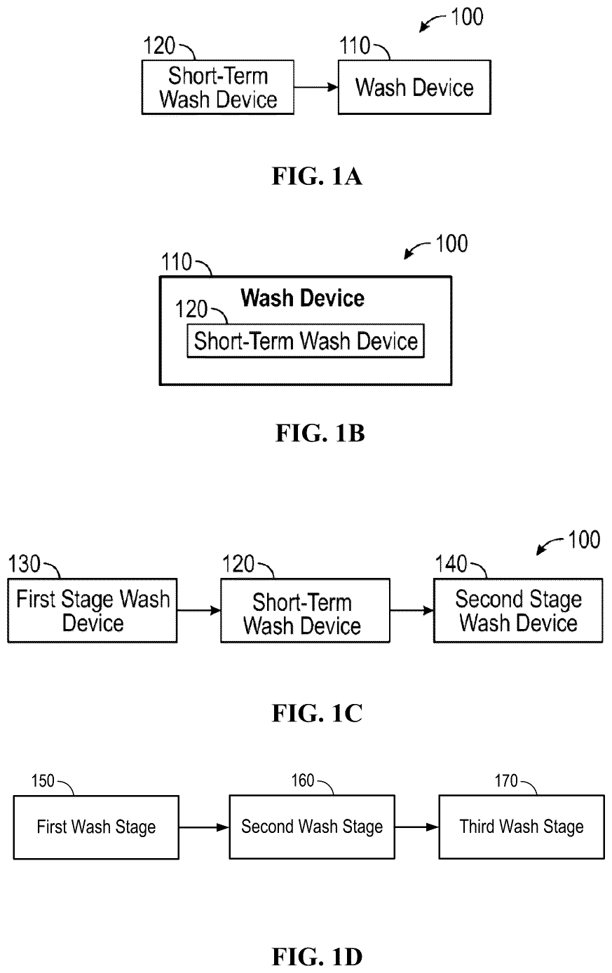

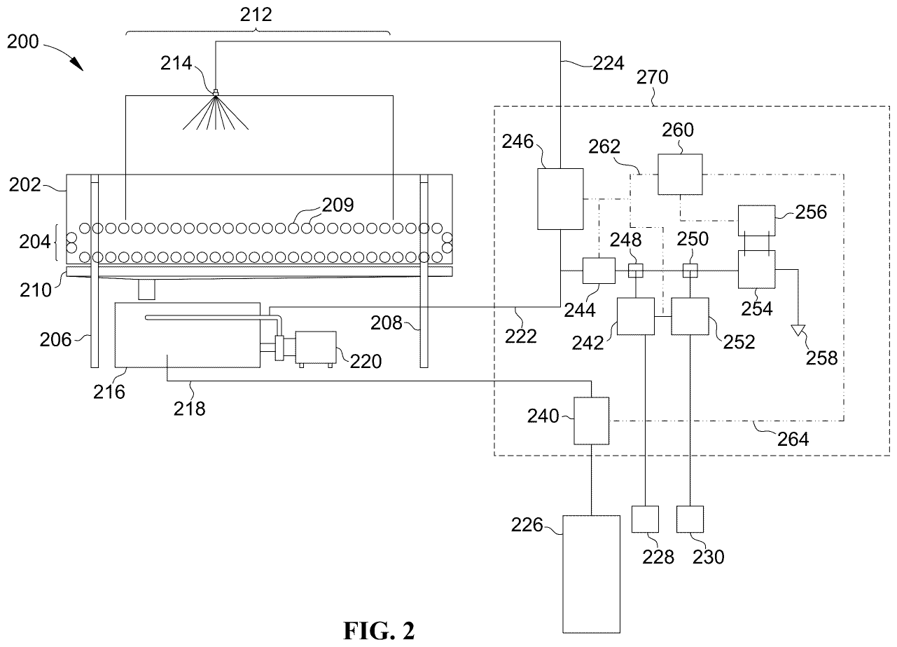

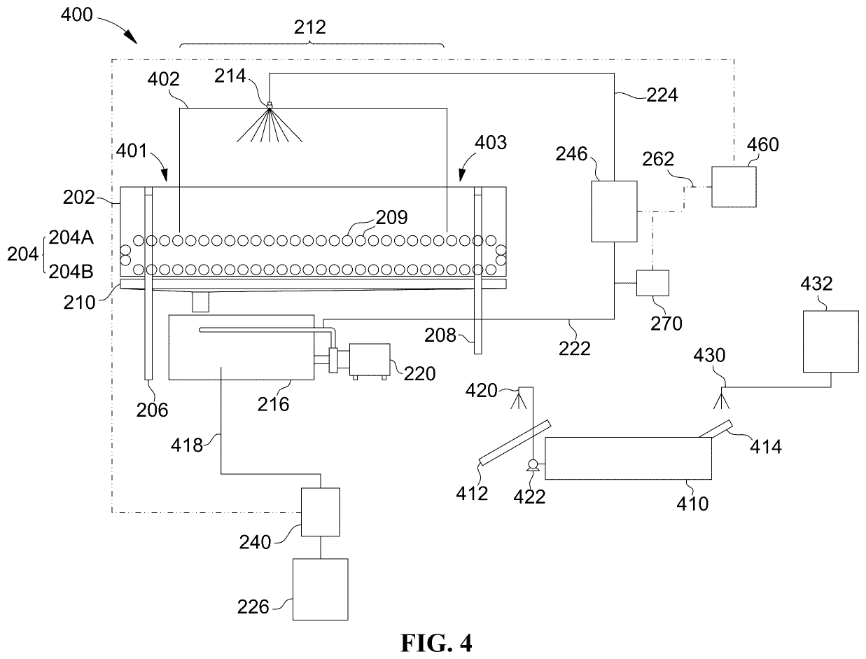

FIGS. 1A, 1B, 1C, and 1D show block diagrams of an example food product wash system 100 for washing food products, such as round produce or meat (e.g., poultry). For example, FIG. 1A shows a food product wash system 100 that includes a wash device 110 and a short-term wash device 120. The short-term wash device 120 is placed to be disposed first in the process flow. Next is provided a wash device 110 that is provided downstream of the short-term wash device 120 in the process flow such that the wash device 110 receives product/produce from the short-term wash device 120. Particularly, the short-term wash device 120 initially washes product and then provides the product to the wash device 110 which rinses the product and washes the product using a normal wash cycle. Each of the wash device 110 and the short-term wash device 120 may include a wash stage, as described herein with respect to FIGS. 2 and 4.

FIG. 1B shows a food product wash system 100 that includes a wash device 110 and a short-term wash device 120. In this example, the short-term wash device 120 is provided at some point within the wash device 110. Accordingly, product that is provided to the wash device 110 will first be washed by the short-term wash device 120 and then provided to the wash device 110 for rinsing and a normal wash cycle.

FIG. 1C shows a food product wash system 100 that includes a short-term wash device 120, as well as a first stage wash device 130 and a second stage wash device 140. The first stage wash device 130 is provided before both the short-term wash device 120 and the second stage wash device 140. Accordingly, the first stage wash device 130 does a preliminary normal wash cycle or rinse. The short-term wash device 120 is provided next to receive the product from the first stage wash device 130. The short-term wash device 120 then washes the product using a short-term wash treatment and sends the product on to the second stage wash device 140. The second stage wash device 140 receives the product and proceeds to rinse and wash the product using a normal wash cycle similar to the first stage wash device 130. Providing the first stage wash device 130 first allows that wash cycle to deal with the initial product load so that the short-term wash treatment can be better controlled and applied consistently to the product. Each of the short-term wash device 120, first stage wash device 130, and the second stage wash device 140 may include a wash stage, as described herein with respect to FIGS. 2 and 4.

FIG. 1D shows a food product wash system 100 that includes a first wash stage 150, a second wash stage 160, and a third wash stage 170, according to certain aspects of the present disclosure. The first wash stage 150 may apply a first wash treatment solution (e.g., including silver ion) to an exterior of an item of produce, as described herein. The second wash stage 160 may apply a second wash treatment solution (e.g., including an acidulant) to the exterior of the item of produce, as described herein. The third wash stage 170 may apply a third wash treatment solution (e.g., including chlorine) to the exterior of the item of produce, as described herein. In some aspects, the first wash stage 150 or the second wash stage 160 may be replaced with a mixing stage for blending raw materials of a wash treatment solution before applying this wash treatment solution in the next stage. Thus, this mixing stage may be upstream of the second wash stage 160 or the third wash stage 170.

FIG. 2 is a block diagram of a food processing system 200 (also referred to herein as a “process line”) with an example wash stage, in accordance with certain aspects of the present disclosure. In FIG. 2, pipes for conveying fluids are shown as solid lines, while wires for control signals are shown as two short dashes between longer dashes. While control signals are illustrated as occurring on wires, the present disclosure is not so limited, and at least some control signals may be conveyed wirelessly. Although a single wash stage is illustrated in FIG. 2, it is to be understood that the food processing system 200 may include multiple wash stages. In other words, the food processing system 200 may be a single-stage food processing system or part of a multi-stage food processing system. The wash stage in the food processing system 200 may be an example of any of the wash stages or wash devices illustrated in FIGS. 1A-1D. In some aspects, the food processing system 200 may support a single produce line, whereas in other aspects, the food processing system 200 may support multiple produce lines (e.g., five or six lines).

As shown, the food processing system 200 includes a food processing container 202 that contains a food product (e.g., fruit with a rough surface (e.g., a reticulated surface), such as netted melons) being processed. The food product may be supplied to the food processing container 202 via a conveyor (not shown) or other device (e.g., a hopper or dumper), and the food product may be removed from the food processing container 202 via another conveyor (not shown). The food product may be conveyed via a roller conveyor belt 204 through an applicator 212 (e.g., a spray curtain or fogging chamber) in which a wash treatment solution is applied to (e.g., sprayed or misted on) the food product. The roller conveyor belt 204 may be composed of a frame with legs 206, 208 and a plurality of rollers 209. A motor (not shown) and a drive belt (not shown) may be used to turn the rollers 209 and convey the food product in the desired direction along the roller conveyor belt 204. For some examples, the applicator 212 may include one or more nozzles 214, and the wash treatment solution may be applied to the food product via the one or more nozzles 214.

Wash treatment solution may exit the applicator 212 and food processing container 202 via the bottom (e.g., through a screen or holes) of the food processing container 202. At least some of the wash treatment solution that exits the food processing container 202 may be caught in a catch tray 210, which may drain into a wash treatment solution reservoir 216.

Wash treatment solution may be pumped by a pump 220 from the wash treatment solution reservoir 216 via a line 222 (e.g., a pipe or tube). Most of the wash treatment solution from the wash treatment solution reservoir 216 may be supplied to a high pressure pump 246. Wash treatment solution supplied to the high pressure pump 246 may be pumped by the high pressure pump 246 via a line 224 (e.g., a pipe or tube) to the nozzle(s) 214.

A system 270 for controlling the wash treatment, including controlling the composition of the wash treatment solution, may be included in the food processing system 200. As shown in FIG. 2, the system 270 includes the high pressure pump 246, at least one controller 260 (e.g., a programmable logic controller (PLC), programmable logic device (PLD), field-programmable gate array (FPGA), application specific integrated circuit (ASIC), etc.) or other processor(s), a sample metering pump 244, a first reagent metering pump 242, a second reagent metering pump 252, an optical chamber 254, a spectrometer 256, and a metering pump 240.

For certain aspects, at least some of the components of the system 270 may be enclosed by a housing or other enclosure to protect the components from damage and the ambient environment in which the system 270 is used. The box outlining the system 270 may also represent the housing, in some aspects. This housing or other enclosure may include one or more feedthroughs for various electrical and/or fluid lines (e.g. lines 218, 222, 224). In such cases, the system 270 may be configured as a portable unit that may be disconnected from one food processing system and connected to another food processing system. This portable unit may be connected to and disconnected from, for example, a water supply, one or more reservoirs, and/or one or more electrical and/or fluid lines of a food processing system. For certain aspects, the system 270 may include an intrinsic water supply, which may supply deionized water for generating the wash treatment solution, such as in food processing systems with relatively low wash treatment solution volume demands. For other aspects, the system 270 may include a filter configured to fluidly couple to an external water supply and filter the water to generate deionized quality water for producing the wash treatment solution. For food processing systems with relatively high wash treatment solution volume demands, the system 270 may not include an intrinsic water supply, or the intrinsic water supply can be disconnected or otherwise disabled such that an external water supply may be used with the system 270.

The controller 260 may control operations of the system 270 and may also control operations of the food processing system 200, according to certain aspects of the present disclosure. For example, the controller 260 may be or may include an Automated SmartWash Analytical Platform (ASAP)™ (available from SmartWash Solutions, LLC of Salinas, California). In certain aspects, the controller 260 may be the only controller (e.g., the only PLC) in the food processing system 200. For example, the controller 260 may control both wash treatment solution composition and delivery. In some aspects, the controller 260 may receive one or more indications of one or more parameters measured, sensed, or otherwise determined by one or more sensors (e.g., chemical sensors, temperature sensors, optical sensors, and the like) in the food processing system 200. The controller 260 may process the indication(s) and, in some aspects, send one or more control signals to one or more components (e.g., one or more pumps and/or valves) of the food processing system 200, based on the indication(s).

The sample metering pump 244 may obtain a sample stream of wash treatment solution from the line 222. The sample metering pump 244 may pump the sample stream of the wash treatment solution at a controlled rate to a Venturi mixing tube 248 or another means of mixing fluids.

The first reagent metering pump 242 may pump a first reagent from a first reagent reservoir 228 at a controlled rate to the Venturi mixing tube 248. The first reagent and the sample stream of the wash treatment solution may mix in the Venturi mixing tube 248. As previously described herein, the first reagent may cause the sample stream to have a pH in a desired range.

From the Venturi mixing tube 248, the sample stream (having the desired pH) may flow to another Venturi mixing tube 250 or other means of mixing fluids. The second reagent metering pump 252 may pump a second reagent from a second reagent reservoir 230 at a controlled rate to the Venturi mixing tube 250. The second reagent and the sample stream of the wash treatment solution (having the desired pH) may mix in the Venturi mixing tube 250. As previously described herein, the second reagent may reduce silver ions in the sample stream to form colloidal silver in the sample stream.

From the Venturi mixing tube 250, the sample stream with the colloidal silver may flow to an optical chamber 254. The spectrometer 256 or other optical meter may measure an optical property of the sample stream in the optical chamber 254 and convert this measured optical property to an indication of a concentration of the colloidal silver. The spectrometer 256 or other optical meter provides the indication of the concentration of the colloidal silver in the sample stream to the controller 260. From the optical chamber 254, the sample stream may be dumped (e.g., down a drain) via an outlet 258 to a waste disposal facility, for example.

In certain aspects of the present disclosure, the controller 260 may control (e.g., by sending a control signal to a pump or a valve) addition of at least one of a silver ion solution, an acidulant, a polyol, and/or chlorine-free water to the wash treatment solution reservoir 216, based on the indication of the concentration of the colloidal silver obtained from the spectrometer 256 or other optical meter. For example, based on the indication of the concentration of the colloidal silver in the sample stream, the controller 260 may send one or more control signals via wire 264 to the metering pump 240 to cause the metering pump to pump silver ion solution (e.g., silver dihydrogen citrate) via a line 218 (e.g., a pipe or tube) from a reservoir 226 to the wash treatment solution reservoir 216.

According to certain aspects, the raw materials of the wash treatment solution (e.g., the silver ion solution, the acidulant, the polyol, and/or chlorine-free water) may be blended to form the wash treatment solution. The raw materials may be mixed using Venturi mixers (e.g., similar to the Venturi mixing tubes 248, 250) for proportional blending. For example, the raw materials may be provided to the Venturi mixers (or other means for mixing) by pumping the raw materials using one or more pumps (similar to and including metering pump 240) from one or more reservoirs (similar to and including reservoir 226). The output of the blending may be provided to the wash treatment solution reservoir 216 (e.g., via line 218) or to the high pressure pump 246, for example. The blending may occur in the wash stage of the food processing system 200 or in a mixing stage (not shown) upstream of the wash stage. In other words, the mixer(s), the pump(s) (including pump 240), and the reservoir(s) (including reservoir 226) may be considered and function as being part of the same wash stage as shown in the food processing system 200 of FIG. 2 or may be considered and function as part of a separate mixing stage upstream of this wash stage.

As described above, this blending of the raw materials may be controlled by a controller, such as the controller 260. For example, the controller 260 may send one or more control signals via one or more wires (similar to and/or including wire 264) to the pump(s) (including pump 240) to cause the pump(s) to pump one or more of the raw materials via one or more lines from the reservoir(s) to the mixing means (e.g., the Venturi mixers).

In some cases, the wash treatment solution is a perishable solution having a limited shelf life for a defined efficacy (e.g., due to light sensitivity of silver). Thus, this blending of the raw materials may occur just before and/or during washing of the round produce or other food products in the food processing system 200. For example, the wash treatment solution may be used to wash the food products within a few minutes (e.g., within 2 minutes, or in some cases within 1 minute) after blending the raw materials. This hold time of the blended wash treatment solution may be based on the volume of the delivery line (the length and diameter or width of the line) versus the application rate of the solution (e.g., the spray rate). This on-demand and in situ blending may be based on the control signals generated by the controller 260 to maintain desired concentrations of the wash treatment solution constituents and avoids mixing the raw materials significantly before the wash treatment solution will actually be used to treat the food product. In such cases where the raw materials are blended just before and/or during product washing, there may be no holding reservoir (e.g., no wash treatment solution reservoir 216).

In certain aspects of the present disclosure, the controller 260 may also control the operations (e.g., pump rate) of the sample metering pump 244, the first reagent metering pump 242, and/or the second reagent metering pump 252, via one or more wires 262 or a bus. The controller 260 may also control the operation of the high pressure pump 246 via the wires 262 or the bus. The pumps described herein (e.g., the sample metering pump 244, the first reagent metering pump 242, and/or the second reagent metering pump 252) may be, for example, electronically controlled pumps, mechanical flow-based pumps, or any combination thereof. As used herein, mechanical flow-based pumps generally refer to devices that use mechanical motion to move a fluid (liquid or gas) from one location to another. For example, a mechanical flow-based pump may be a non-electric pump that uses flowing process water to actuate the pump (e.g., to send the fluid into the Venturi mixer).

According to certain aspects of the present disclosure, the controller 260 may also obtain an indication (e.g., a measurement) of a quantity of wash treatment solution present in the wash treatment solution reservoir 216 and control (e.g., by sending a control signal to a pump or a valve) addition of at least one of an acidulant, a polyol, and/or chlorine-free water to the wash treatment solution reservoir 216, based on the indication of the quantity. In certain aspects of the present disclosure, the controller 260 may also obtain an indication (e.g., a measurement) of a pH of the wash treatment solution and control (e.g., by sending a control signal to a pump or a valve) addition of at least one of sodium hydroxide (NaOH), potassium hydroxide (KOH), an acidulant, a polyol, and/or chlorine-free water to the wash treatment solution reservoir 216 or to the sample stream, based on the indication of the pH.

There may be a tradeoff between the conductivity of the chlorine-free water and the silver consumption in the food processing system 200, where higher conductivity (lower resistivity) water has a greater silver consumption than lower conductivity (higher resistivity) water. While water with a resistivity of 1000 kΩ may have lower silver consumption (e.g., of 0.11 ppm), water with a resistivity of 500 kΩ or even lower may be suitable for use in the food processing system 200 (e.g., with a silver consumption of 0.22 ppm) and may have lower cost.

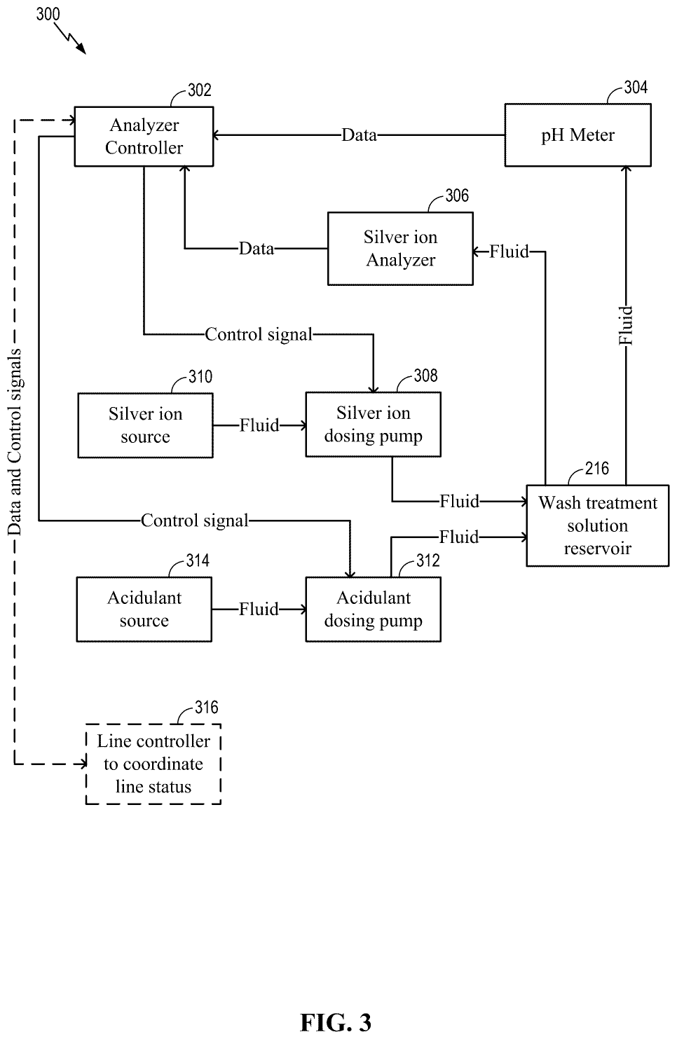

FIG. 3 is a block diagram of a wash treatment solution control system 300, in accordance with certain aspects of the present disclosure. As illustrated in FIG. 3, an analyzer controller 302 (which may be similar to the controller 260 shown in FIG. 2) may obtain an indication of pH of the wash treatment solution from a pH meter 304 that measures the pH of the wash treatment solution obtained from or in the wash treatment solution reservoir 216 (or a wash stage or mixing stage, such as in cases where the solution components are blended on demand). The analyzer controller 302 may also obtain an indication of a concentration of silver ions in the wash treatment solution from a silver ion analyzer 306 (e.g., the spectrometer 256, shown in FIG. 2). The analyzer controller 302 may send control signals, based on the indication of the concentration of silver ions in the wash treatment solution, to a silver ion dosing pump 308 (which may be similar to the metering pump 240, shown in FIG. 2) to cause the silver ion dosing pump to add silver ions from a silver ion source 310 (e.g., a reservoir of silver dihydrogen citrate solution) to the wash treatment solution reservoir 216 (or wash/mixing stage). The analyzer controller 302 may also send control signals, based on the indication of the pH of the wash treatment solution, to an acidulant dosing pump 312 to cause the acidulant dosing pump to add an acidulant (e.g., lactic acid) from an acidulant source 314 (e.g., a reservoir of lactic acid solution) to the wash treatment solution reservoir 216 (or wash/mixing stage). The analyzer controller 302 may also optionally exchange data and control signals with an optional food processing controller 316 to coordinate the wash treatment solution control system 300 with other parts of a food processing system (e.g., one or more wash stages).

As described above, the raw materials of the wash treatment solution (e.g., the silver ion solution, the acidulant, the polyol, and/or chlorine-free water) may be blended (e.g., just before use, such as within a few minutes after generation, such as within 2 minutes) to generate the wash treatment solution for use in treating the round produce or other food product. This blending may be based on the control signals generated by the analyzer controller 302.

### Example Apparatus for Mitigating Pathogen Contamination on Round Produce

FIG. 4 is a schematic view of an example food processing system 400 for washing at least one item of round produce, in accordance with certain aspects of the present disclosure. The food processing system 400 may include similar components as the food processing system 200 described herein with reference to FIG. 2. Components of the food processing system 200 previously described herein are not further described. Although round produce is described herein as an example food product, it is to be understood that other food products may be substituted for round produce, in the food processing system 400 and other aspects of the present disclosure.

As shown, the system 400 includes at least one controller 460 that may be similar to the at least one controller 260 of FIG. 2 and may control the operation of the food processing system 400 in a similar manner as the controller 260 controls the food processing system 200 in FIG. 2. The reservoir 226 may hold a wash treatment solution which may be, for example, a silver ion solution (e.g., a solution of silver dihydrogen citrate).

The food processing system 400 includes a first wash stage that includes the roller conveyor belt 204 and the applicator 212. The roller conveyor belt 204 is illustrated as having an upper portion 204A and a lower portion 204B. The first wash stage further includes an opaque shroud 402 (e.g., a cowling) configured to prevent light from impinging on items of produce and the wash treatment solution within the shroud 402. The opaque shroud 402 may be composed of any of various suitable food-grade materials, such as metal (e.g., stainless steel) or plastic (e.g., polyethylene). At least one surface (e.g., the interior) of the opaque shroud 402 may be black or another dark color. In certain aspects, the opaque shroud 402 may provide a framework for the applicator 212 (e.g., for suspending the spray bars). The opaque shroud 402 may include curtains at an entrance 401 of the opaque shroud and/or at an exit 403 of the opaque shroud. The curtains may prevent light from impinging on the items of produce and the wash treatment solution within the shroud 402 while allowing the items of produce to be conveyed by the roller conveyor belt 204 under and out of the shroud 402. In certain aspects, the curtains may be implemented as strip curtains and may comprise black plastic, for example. In certain aspects, the opaque shroud 402 may have one or more access ports (e.g., doors or panels) that may be opened to allow temporary access to the interior of the shroud.

During operation of the system 400, one or more items of round produce (e.g., melons, apples, peaches, onions, or tomatoes) or other food products may enter the food processing system 400 from the conveyor or other device (e.g., a hopper) coupled to a start (or an initial portion) of the roller conveyor belt 204. An opening in the food processing container 202 and/or at the entrance 401 of the shroud 402 towards the distal end of the conveyor may be of a size (e.g., height and/or width) that only a single item of round produce can enter the food processing container 202 and/or the shroud 402 at a time, and another item of round produce cannot enter the food processing container 202 and/or the shroud 402 until after the roller conveyor belt 204 conveys the previous item of round produce away from the container. For other aspects, the opening in the food processing container 202 and/or at the entrance 401 of the shroud 402 may have a height such that a single horizontal layer of round produce can enter the food processing container 202 and/or the shroud 402. The opening to ensure singulation of the produce may be adjustable in one or more dimensions (e.g., an adjustable height and/or an adjustable width), such that the system 400 can accommodate different types of produce (or other food products) with different dimensions and/or can accommodate a single item of produce (or a single horizontal layer of multiple round produce items) at one time.

In certain aspects, the opening in the food processing container 202 and/or at the entrance 401 of the shroud 402 may contain fingers, dividers, or other suitable means for laterally separating items of round produce, such that the individual items of round produce are not touching within a zone of application by the applicator 212 within the shroud 402 (thereby creating multiple individual produce channels within the shroud 402). These fingers may extend in a downward direction from a top of the opening in the food processing container 202 and/or the shroud 402 or may extend in a downward direction from a knock-down bar or other structure placed upstream of the opening in the food processing container 202 and/or the shroud 402. These fingers may be laterally movable, such that the lateral spacing between the fingers may be adjusted (e.g., to accommodate different types of produce (or other food products) with different dimensions.

The roller conveyor belt 204 may be configured with a plurality of rollers to rotate the round produce as the produce traverses the length of the roller belt. The length of the roller conveyor belt 204 in at least the zone of application by the applicator 212 may be designed to have a sufficient length such that each item of produce is rotated at least twice in the zone of application and for at least a particular application time (e.g., at least 30 seconds), in an effort to ensure complete coverage and sufficient wash treatment of the entire surface of each individual item of produce. For example, for cantaloupes, this length of the roller conveyor belt 204 may be 5 to 10 ft (1.5 to 3 m). For certain aspects, at least some of the rollers in the roller conveyor belt 204 may have tread thereon, for example, to assist in conveying items of round produce along the roller conveyor belt. The roller conveyor belt 204 is configured to convey items of round produce through the applicator 212.

While the applicator 212 is illustrated as having a single nozzle 214 (or a row of nozzles in this cross-sectional view) positioned above the roller conveyor belt 204, it is to be understood that the illustrated nozzle may represent a plurality of nozzles 214 (e.g., multiple spray bars), spaced above at least a portion of the roller conveyor belt 204. The nozzle(s) 214 may be positioned above the upper portion 204A of the roller conveyor belt 204. Additionally or alternatively, one or more nozzles 214 may be disposed between the upper portion 204A and the lower portion 204B of the roller conveyor belt 204, in an effort to apply a wash treatment solution to the items of round produce and/or to the rollers themselves. The applicator 212 and the roller conveyor belt 204 are together configured to apply a wash solution to an entire exterior surface of each item of round produce. The roller conveyor belt 204 may be constructed with sufficient spacing between rollers to enable the wash treatment solution to drain from the items of produce into the food processing container 202 (and from there into the catch tray 210). In certain aspects, the space between rollers may also enable the wash treatment solution sprayed from the nozzles 214 between the upper portion 204A and the lower portion 204B to contact items of produce.

As illustrated, the system 400 further includes a second wash stage 410 configured to apply a second wash treatment solution (or a rinse solution, such as potable water) to the exterior surface of the one or more items of round produce. The second wash treatment solution (or potable water) may act to rinse the first wash treatment solution from the exterior surface of the one or more items of produce. The second wash stage 410 may include, for example, a spray curtain or a tank in which items of produce may be immersed.

The system 400 may optionally include a conveyor 412 for conveying items of produce from the first wash stage to the second wash stage 410. The conveyor 412 is optional, as the conveyor (not shown) coupled to the end (or a final portion) of the roller conveyor belt 204 may convey items of produce directly from the food processing container 202 to the second wash stage 410. The system 400 may also optionally include a conveyor 414 that may convey items of produce out of the second wash stage 410. In other aspects, means other than conveyor 414 (e.g., manual removal) may convey items of produce out of the second wash stage 410.

In some aspects of the present disclosure, the second wash treatment solution may be a solution of chlorine and/or an acidulant (e.g., lactic acid, tartaric acid, citric acid, or phosphoric acid) in water. In other aspects, the second wash treatment solution may additionally or alternatively include other ingredients, such as SmartWash SW™ or SmartWash SWO™ in water.

In some aspects of the present disclosure, the system 400 includes an optional sprayer 420 that rinses items of produce before the items of produce enter the second wash stage 410, such as when the items of produce are on the conveyor 412 or the other conveyor coupled to the end of the roller conveyor belt 204. An optional pump 422 may supply rinsing fluid or a third wash treatment solution to the sprayer 420.

In some aspects of the present disclosure, the system 400 includes an optional water sprayer 430 that sprays potable water (or other suitable rinse solution) from a potable water source 432 (or other source) on items of produce that are removed from the second wash stage 410. The potable water may act to remove the second wash treatment solution from items of produce.

According to certain aspects, the system 400 may include one or more cameras (not shown). The camera(s) may be used to detect spacing between items of produce and ensure proper singulation (e.g., whether items of produce are spaced apart (in some case, by a specified separation distance) or whether any items of produce are touching) through the zone of application. Additionally or alternatively, the camera(s) may be used to detect whether produce is present on the roller conveyor belt, detect and ensure items of produce are rotated a minimum number of times through the application of the wash treatment, and/or detect and ensure proper coverage of the items of produce (e.g., by detecting coverage of the shower or mist). In certain aspects, a single camera with a wide-angle lens may be used, and this camera may be placed at or near a central location with respect to the zone of application. In other aspects, a camera may be disposed near each sprayer or row of nozzles at each position above the roller conveyor belt (e.g., one camera per sprayer). In certain aspects, the camera(s) may be used to monitor the nozzles for occlusion (e.g., clogging) or irregular flow. The camera(s) may use white, ultraviolet (UV), or blue light (e.g., Food and Drug Administration (FDA)-approved blue light), for example. At least one of the cameras may use a fisheye lens in some cases, although any of various other suitable lenses may be used. The camera(s) may be communicatively coupled to a processor (e.g., the controller 460) for processing the images or video captured by the camera(s).

As described above, the system 400 may perform mist density estimation using specific wavelengths of light produced by a light source and received by a sensor. The mist density may be estimated based on the amount of transmittance (or absorption) of light at the receiving sensor.

### Example Methods of Mitigating Pathogen Contamination on an Item of Produce

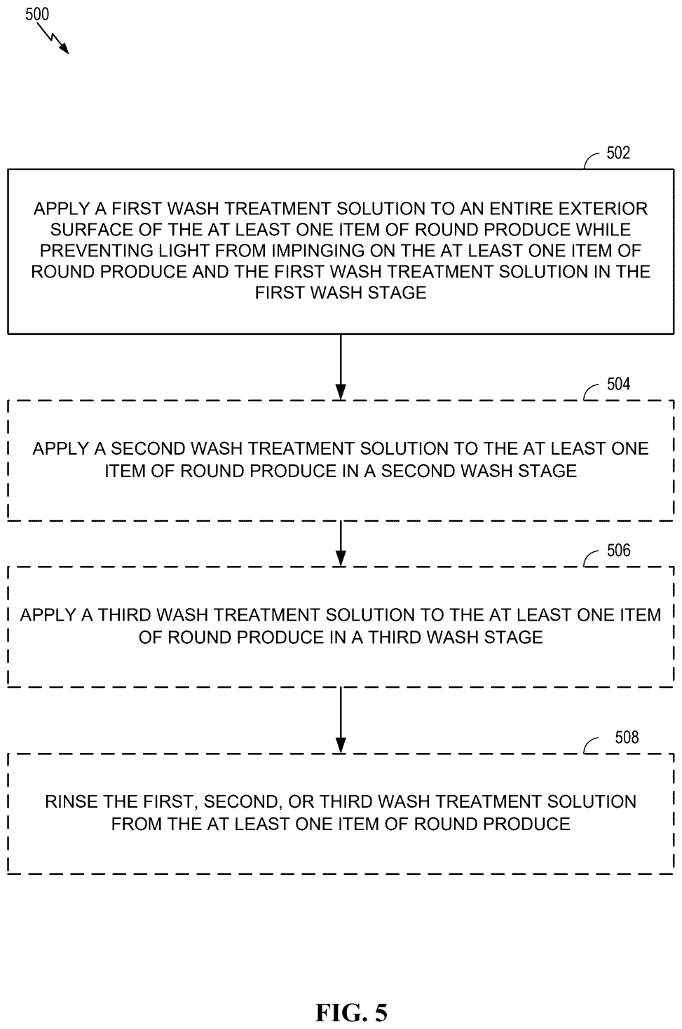

FIG. 5 is a flow diagram of example operations 500 for washing at least one item of round produce, in accordance with certain aspects of the present disclosure. The operations 500 may be performed by a food processing system for washing at least one item of round produce (e.g., the system 400 in FIG. 4). The system may be controlled by at least one controller (e.g., the controller 260, 460) and/or by an operator. Although the description of FIG. 5 is directed to round produce as an example food product, it is to be understood that the operations 500 may also apply to other food products.

The operations 500 may begin, at block 502, by applying a first wash treatment solution to an entire exterior surface of the at least one item of round produce in a first wash stage while preventing light from impinging on the at least item of round produce and the first wash treatment solution in the first wash stage. For example, a first wash stage (e.g., including the food processing container 202, the applicator 212, and the opaque shroud 402) in the system 400 may apply a first wash treatment solution (e.g., a silver ion solution) to an entire exterior surface of at least one item of round produce (e.g., cantaloupes) while preventing light from impinging on the at least one item of round produce and the first wash treatment solution in the first wash stage.

In certain aspects of the present disclosure, applying the first wash treatment solution comprises spraying or misting the first wash treatment solution on the at least one item of round produce using a plurality of spray nozzles. For example, a first wash treatment solution may be sprayed or misted from one or more nozzles 214 onto an item or round produce in the food processing system 400 shown in FIG. 4.

In certain aspects of the present disclosure, applying the first wash treatment solution comprises moving the item of round produce through the first wash stage using a roller conveyor belt. In such aspects, the roller conveyor belt has a length that is sufficient to ensure that each item of round produce rotates at least two times in the first wash stage. For example with reference to FIG. 4, an item of round produce may be moved through the first wash stage using the roller conveyor belt 204. The roller conveyor belt 204 is long enough that each item of round produce rotates at least two times between a first time when the item enters the opaque shroud 402 (or a zone of spray application from the applicator 212) and a second time when the item exits the opaque shroud.

In certain aspects of the present disclosure, the at least one item of round produce of block 502 comprises two or more items of round produce, and the applying comprises preventing each of the two or more items of round produce from contacting another of the two or more items of round produce in the first wash stage. For example, two cantaloupes may enter the food processing container 202 via the conveyor (coupled to the start of the roller conveyor belt 204), and an opening at the end of the conveyor and/or at the entrance 401 may be of a size (e.g., height and/or width) such that only a first cantaloupe can enter the zone of application in the first wash stage and a second cantaloupe cannot enter the zone of application in the first wash stage until after the roller conveyor belt 204 conveys the first cantaloupe away from the conveyor or the entrance 401. The roller conveyor belt 204 may be configured to prevent each cantaloupe from contacting another cantaloupe in the zone of application in the first wash stage.

In certain aspects of the present disclosure, the first wash stage comprises opaque curtains disposed at at least one of an entrance or an exit of the first wash stage (or of the opaque shroud). For example, the opaque shroud 402 may include opaque curtains (e.g., black plastic strip curtains) at the entrance 401 of the opaque shroud 402 and/or at the exit 403 of the opaque shroud 402.

In certain aspects of the present disclosure, the first wash treatment solution comprises a silver ion solution. For example, the applicator 212 in the first wash stage, shown in FIG. 4, may apply a silver ion solution to the at least one item of round produce in the food processing container 202.

In some aspects of the present disclosure, the operations 500 may optionally further include, at block 504, applying a second wash treatment solution to the at least one item of round produce in a second wash stage. The second wash stage may be downstream or upstream of the first wash stage. For example, a second wash treatment solution may be applied to the at least one item of produce by the second wash stage 410 of the system 400 shown in FIG. 4. In some aspects of the present disclosure, the second wash treatment solution comprises chlorine and/or SmartWash SW™. In some aspects of the present disclosure, the second wash treatment solution comprises an acidulant. In such cases, the acidulant may include lactic acid.

In some aspects of the present disclosure, the operations 500 may optionally further include, at block 506, applying a third wash treatment solution to the at least one item of round produce in a third wash stage. The third wash stage may be downstream or upstream of the second wash stage. The third wash stage may be downstream or upstream of the first wash stage. In some aspects, the third wash treatment solution comprises chlorine and/or SmartWash SW™.

In some aspects of the present disclosure, the operations 500 may optionally further include, at block 508, rinsing the first wash treatment solution, the second wash treatment solution, or the third wash treatment solution from the at least one item of round produce.

### Example Methods of Mitigating Pathogen Contamination on a Food Product

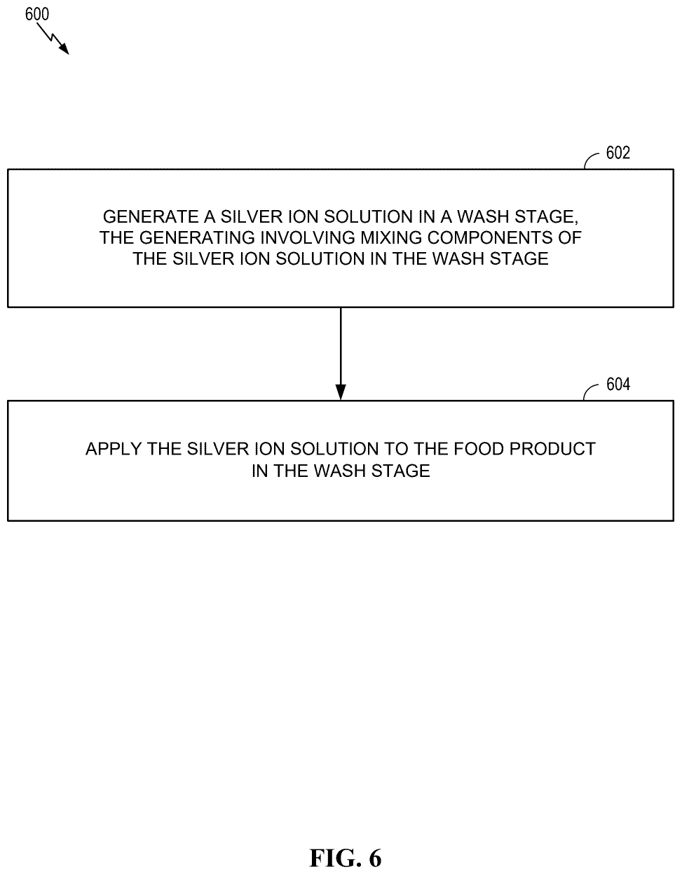

FIG. 6 is a flow diagram of example operations 600 for washing a food product (e.g., meat, such as poultry, or fresh produce, such as an item of round produce), in accordance with certain aspects of the present disclosure. The operations 600 may be performed by a food processing system for washing a food product (e.g., the system 400 in FIG. 4). The food processing system may be controlled by at least one controller (e.g., the controller 260, 460) and/or by an operator.

The operations 600 may begin, at block 602, with the food processing system generating a silver ion solution in a wash stage. Generating the silver ion solution may involve mixing components of the silver ion solution in the wash stage. At block 604, the food processing system may apply the silver ion solution to the food product in the wash stage.

According to certain aspects, generating the silver ion solution in the wash stage at block 602 includes mixing silver dihydrogen citrate, an acidulant, a polyol, and chlorine-free water in the wash stage.

In some aspects, generating the silver ion solution at block 602 involves generating the silver ion solution on-demand in the wash stage. For example, the silver ion solution may be generated at block 602 while the wash stage is operating (e.g., while the wash stage is applying the silver ion solution to the food product at block 604).

According to certain aspects, the food product includes an item of round produce. In this case, the applying at block 604 may involve applying the silver ion solution to an entire exterior surface of the item of round produce in the wash stage.

In some aspects, the food processing system may apply the silver ion solution to the food product at block 604 within two minutes after the silver ion solution is generated at block 604.

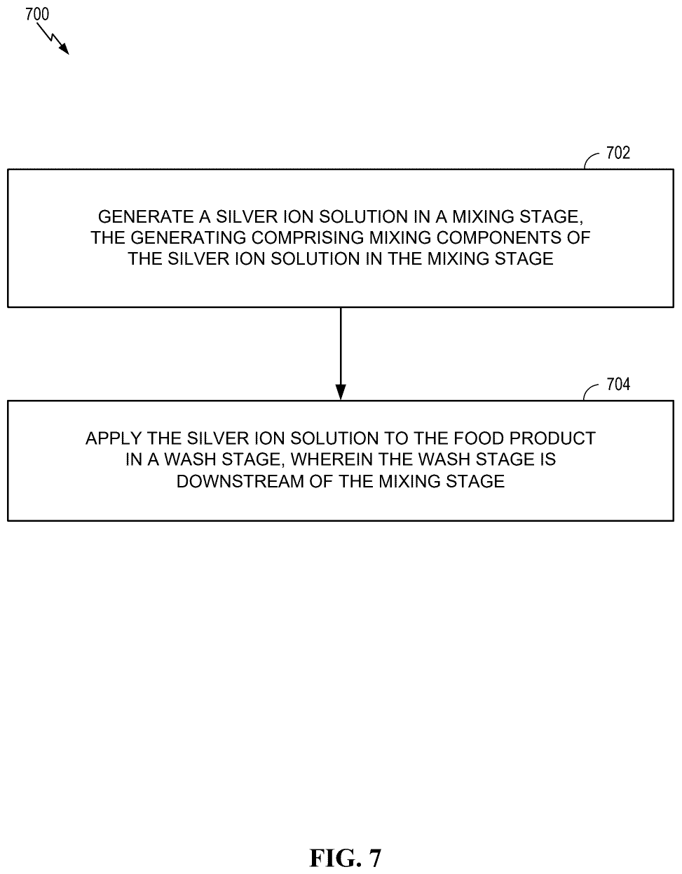

FIG. 7 is a flow diagram of example operations 700 for washing a food product (e.g., meat, such as poultry, or fresh produce, such as an item of round produce), in accordance with certain aspects of the present disclosure. The operations 700 may be performed by a food processing system for washing a food product (e.g., the system 400 in FIG. 4). The food processing system may be controlled by one or more controllers (e.g., the controller 260, 460) and/or by an operator.

The operations 700 may begin, at block 702, with the food processing system generating a silver ion solution in a mixing stage. The generating at block 702 may involve mixing components of the silver ion solution in the mixing stage. In certain aspects, generating the silver ion solution at block 702 includes mixing silver dihydrogen citrate, an acidulant, a polyol, and chlorine-free water in the mixing stage.

At block 704, the food processing system may apply the silver ion solution to the food product in a wash stage. The wash stage may be downstream of the mixing stage. In some aspects, the food processing system applies the silver ion solution to the food product within two minutes after the silver ion solution is generated at block 702.

According to certain aspects, the food product includes an item of round produce. In this case, the applying at block 704 may involve applying the silver ion solution to an entire exterior surface of the item of round produce in the wash stage.

### EXAMPLE ASPECTS

In addition to the various aspects described above, specific combinations of aspects are within the scope of the present disclosure, some of which are detailed below.

Aspect 1: An apparatus for washing at least one item of round produce, comprising: an applicator configured to apply a first wash treatment solution to an entire exterior surface of the at least one item of round produce; and an opaque shroud configured to prevent light from impinging on the at least one item of round produce and the first wash treatment solution.

Aspect 2: The apparatus of Aspect 1, wherein the opaque shroud is configured to prevent the light from impinging on the at least one item of round produce and the first wash treatment solution while the applicator is applying the first wash treatment solution to the entire exterior surface of the at least one item of round produce.

Aspect 3: The apparatus of Aspect 1 or 2, wherein the applicator comprises a plurality of spray nozzles.

Aspect 4: The apparatus of any of Aspects 1-3, further comprising a roller conveyor belt configured to move the at least one item of round produce from an entrance of the opaque shroud to an exit of the opaque shroud and to cause the at least one item of round produce to rotate at least twice while the at least one item of round produce moves from the entrance of the opaque shroud to the exit of the opaque shroud.

Aspect 5: The apparatus of any of Aspects 1-3, further comprising a roller conveyor belt configured to move the at least one item of round produce from an entrance of the opaque shroud to an exit of the opaque shroud, wherein: the at least one item of round produce comprises two or more items of round produce; and the roller conveyor belt is configured to prevent one of the two or more items of round produce from contacting another one of the two or more items of round produce.

Aspect 6: The apparatus of any of Aspects 1-5, further comprising opaque curtains disposed at at least one of an entrance or an exit of the opaque shroud.

Aspect 7: The apparatus of any of Aspects 1-6, wherein the first wash treatment solution comprises a silver ion solution.

Aspect 8: The apparatus of any of Aspects 1-7, wherein the applicator and the opaque shroud are part of a first wash stage, the apparatus further comprising a second wash stage configured to apply a second wash treatment solution to the at least one item of round produce.

Aspect 9: The apparatus of Aspect 8, wherein the second wash stage is downstream of the first wash stage.

Aspect 10: The apparatus of Aspect 8 or 9, wherein the second wash treatment solution comprises chlorine.

Aspect 11: The apparatus of any of Aspects 8-10, wherein the second wash treatment solution comprises an acidulant.

Aspect 12: The apparatus of Aspect 11, wherein the acidulant comprises lactic acid.

Aspect 13: The apparatus of any of Aspects 8-12, further comprising a third wash stage configured to apply a third wash treatment solution to the at least one item of round produce.

Aspect 14: The apparatus of Aspect 13, wherein the third wash treatment solution comprises chlorine.

Aspect 15: The apparatus of Aspect 13 or 14, wherein the third wash stage is downstream of the second wash stage.

Aspect 16: The apparatus of any of Aspects 1-15, further comprising a rinsing device configured to rinse the first wash treatment solution from the at least one item of round produce.

Aspect 17: A method of washing at least one item of round produce, the method comprising applying a first wash treatment solution to an entire exterior surface of the item of round produce in a first wash stage while preventing light from impinging on the item of round produce and the first wash treatment solution in the first wash stage.

Aspect 18: The method of Aspect 17, wherein the applying comprises spraying or misting the first wash treatment solution on the item of round produce using a plurality of spray nozzles.

Aspect 19: The method of Aspect 17 or 18, wherein the applying comprises moving the at least one item of round produce through the first wash stage using a roller conveyor belt and wherein the roller conveyor belt has a length that is sufficient to ensure the at least one item of round produce rotates at least two times in the first wash stage.

Aspect 20: The method of any of Aspects 17-19, wherein the at least one item of round produce comprises two or more items of round produce and wherein the applying comprises preventing each of the two or more items of round produce from contacting another of the two or more items of round produce in the first wash stage.

Aspect 21: The method of any of Aspects 17-20, wherein preventing the light from impinging on the item of round produce comprises using opaque curtains disposed at at least one of an entrance or an exit of the first wash stage.

Aspect 22: The method of any of Aspects 17-21, wherein the first wash treatment solution comprises a silver ion solution.

Aspect 23: The method of any of Aspects 17-22, further comprising generating the silver ion solution in the first wash stage, wherein generating the silver ion solution includes mixing silver dihydrogen citrate, an acidulant, a polyol, and chlorine-free water in the first wash stage.

Aspect 24: The method of any of Aspects 17-22, further comprising generating the silver ion solution, wherein the applying comprises applying the silver ion solution to the item of round produce within two minutes after the silver ion solution is generated

Aspect 25: The method of any of Aspects 17-24, further comprising applying a second wash treatment solution to the at least one item of round produce in a second wash stage.

Aspect 26: The method of Aspect 25, wherein the second wash treatment solution comprises chlorine.

Aspect 27: The method of Aspect 25 or 26, wherein the second wash treatment solution comprises an acidulant.

Aspect 28: The method of Aspect 27, wherein the acidulant comprises lactic acid.

Aspect 29: The method of any of Aspects 25-28, further comprising applying a third wash treatment solution to the at least one item of round produce in a third wash stage.

Aspect 30: The method of Aspect 29, wherein the third wash treatment solution comprises chlorine.

Aspect 31: The method of any of Aspects 17-30, further comprising rinsing the first wash treatment solution from the at least one item of round produce.

Aspect 32: A system for washing at least one item of round produce, comprising: an applicator comprising a plurality of spray nozzles, wherein the plurality of spray nozzles are configured to apply a silver ion solution to an exterior surface of the at least one item of round produce; an opaque shroud enclosing the plurality of spray nozzles and configured to prevent light from impinging on the at least one item of round produce and the silver ion solution during the application of the silver ion solution; and a roller conveyor belt passing through an interior of the opaque shroud, wherein: the roller conveyor belt is configured to move the at least one item of round produce from an entrance of the opaque shroud to an exit of the opaque shroud; and the roller conveyor belt is configured to cause the at least one item of round produce to rotate at least twice while the at least one item of round produce moves from the entrance of the opaque shroud to the exit of the opaque shroud.

Aspect 33: The system of Aspect 32, wherein the at least one item of round produce comprises two or more items of round produce and wherein the entrance of the opaque shroud is configured to prevent a first of the two or more items of round produce from contacting a second of the two or more items of round produce during the application of the silver ion solution.

Aspect 34: The system of Aspect 32 or 33, further comprising a controller for controlling the washing of the at least one item of round produce, the controller being configured to execute executable instructions to cause the controller to: control generation of the silver ion solution in a wash stage comprising the applicator and the opaque shroud, the generation including mixing components of the silver ion solution in the wash stage; and control the application of the silver ion solution to the exterior surface of the at least one item of round produce in the wash stage.

Aspect 35: The system of Aspect 34, wherein to control the generation of the silver ion solution, the controller is configured to execute the executable instructions to cause the controller to control the mixing of silver dihydrogen citrate, an acidulant, a polyol, and chlorine-free water on demand in the wash stage.

Aspect 36: The system of Aspect 34, further comprising one or more Venturi mixers, each Venturi mixer having a control input communicatively coupled to an output of the controller, wherein to control generation of the silver ion solution, the controller is further configured to execute the executable instructions to cause the controller to control the one or more Venturi mixers to control the mixing of silver dihydrogen citrate, an acidulant, a polyol, and chlorine-free water in the wash stage.

Aspect 37: The system of Aspect 36, further comprising one or more pumps, at least one of the pumps being fluidly coupled to one of the Venturi mixers and having a control input communicatively coupled to another output of the controller.

Aspect 38: The system of any of Aspects 34-37, further comprising: a reservoir for containing the silver ion solution; and a pump for fluidly coupling to the silver ion solution in the reservoir, the pump having a control input communicatively coupled to another output of the controller, wherein to control the application of the silver ion solution, the controller is configured to execute the executable instructions to cause the controller to control the pump.

Aspect 39: The system of Aspect 38, wherein the controller is configured to receive an indication of a presence of the at least one item of round produce and to control shutting off the pump when the at least one item of round produce is absent.

Aspect 40: A method of washing a food product, the method comprising: generating a silver ion solution in a wash stage, the generating including mixing components of the silver ion solution in the wash stage; and applying the silver ion solution to the food product in the wash stage.

Aspect 41: The method of Aspect 40, wherein generating the silver ion solution in the wash stage comprises mixing silver dihydrogen citrate, an acidulant, a polyol, and chlorine-free water in the wash stage.

Aspect 42: The method of Aspect 40 or 41, wherein generating the silver ion solution comprises generating the silver ion solution on-demand in the wash stage.

Aspect 43: The method of any of Aspects 40-42, wherein the food product comprises an item of round produce and wherein the applying comprises applying the silver ion solution to an entire exterior surface of the item of round produce in the wash stage.

Aspect 44: The method of any of Aspects 40-43, wherein the applying comprises applying the silver ion solution to the food product within two minutes after the silver ion solution is generated.

Aspect 45: A method of washing a food product, the method comprising: generating a silver ion solution in a mixing stage, the generating comprising mixing components of the silver ion solution in the mixing stage; and applying the silver ion solution to the food product in a wash stage, wherein the wash stage is downstream of the mixing stage.

Aspect 46: The method of Aspect 45, wherein the applying comprises applying the silver ion solution within two minutes after the silver ion solution is generated.

Aspect 47: The method of Aspect 45 or 46, wherein generating the silver ion solution in the mixing stage comprises mixing silver dihydrogen citrate, an acidulant, a polyol, and chlorine-free water in the mixing stage.

Aspect 48: The method of any of Aspects 45-47, wherein generating the silver ion solution comprises generating the silver ion solution on-demand in the mixing stage.

Aspect 49: The method of any of Aspects 45-48, wherein the food product comprises an item of round produce and wherein the applying comprises applying the silver ion solution to an entire exterior surface of the item of round produce in the wash stage.

Aspect 50: A non-transitory computer-readable medium comprising executable instructions that when executed by a processing system, cause the processing system to perform operations for washing a food product, the operations comprising: generating a silver ion solution in a wash stage, the generating including mixing components of the silver ion solution in the wash stage; and applying the silver ion solution to the food product in the wash stage.

Aspect 51: The computer-readable medium of Aspect 50, wherein the mixing comprises mixing silver dihydrogen citrate, an acidulant, a polyol, and chlorine-free water in the wash stage.

Aspect 52: The computer-readable medium of Aspect 50 or 51, wherein generating the silver ion solution comprises generating the silver ion solution on-demand in the wash stage.

Aspect 53: The computer-readable medium of any of Aspects 50-52, wherein the food product comprises an item of round produce and wherein the applying comprises applying the silver ion solution to an entire exterior surface of the item of round produce in the wash stage.

Aspect 54: The computer-readable medium of any of Aspects 50-53, wherein the applying comprises applying the silver ion solution to the food product within two minutes after the silver ion solution is generated.

Aspect 55: A controller for controlling washing of a food product, the controller being configured to execute executable instructions to cause the controller to: control generation of a silver ion solution in a wash stage, the generation including mixing components of the silver ion solution in the wash stage; and control application of the silver ion solution to the food product in the wash stage.

Aspect 56: The controller of Aspect 55, wherein to control the generation of the silver ion solution, the controller is configured to execute the executable instructions to cause the controller to control the mixing of silver dihydrogen citrate, an acidulant, a polyol, and chlorine-free water in the wash stage.

Aspect 57: The controller of Aspect 55 or 56, wherein to control the generation of the silver ion solution, the controller is configured to execute the executable instructions to cause the controller to control the generation of the silver ion solution on-demand in the wash stage.

Aspect 58: The controller of any of Aspects 55-57, wherein the food product comprises an item of round produce and wherein to control the application of the silver ion solution, the controller is configured to execute the executable instructions to cause the controller to control the application of the silver ion solution to an entire exterior surface of the item of round produce in the wash stage.

Aspect 59: The controller of any of Aspects 55-58, wherein to control the application of the silver ion solution, the controller is configured to execute the executable instructions to cause the controller to control the application of the silver ion solution to the food product within two minutes after the silver ion solution is generated.

Aspect 60: The controller of any of Aspects 55-59, wherein the food product comprises poultry.

Aspect 61: The controller of any of Aspects 55-60, wherein the controller is configured to be the only controller in a food processing system and wherein the controller is further configured to execute the executable instructions to cause the controller to: process one or more indications received from one or more sensors in the food processing system; and send one or more control signals to one or more components of the food processing system, based on the one or more indications.

Aspect 62: A non-transitory computer-readable medium comprising executable instructions that when executed by one or more processors, cause the processor(s) to perform operations for washing a food product, the operations comprising: generating a silver ion solution in a mixing stage, the generating including mixing components of the silver ion solution in the mixing stage; and applying the silver ion solution to the food product in a wash stage, wherein the wash stage is downstream of the mixing stage.

Aspect 63: The computer-readable medium of Aspect 62, wherein the mixing comprises mixing silver dihydrogen citrate, an acidulant, a polyol, and chlorine-free water in the mixing stage.

Aspect 64: The computer-readable medium of Aspect 62 or 63, wherein generating the silver ion solution comprises generating the silver ion solution on-demand in the mixing stage.

Aspect 65: The computer-readable medium of any of Aspects 62-64, wherein the food product comprises an item of round produce and wherein the applying comprises applying the silver ion solution to an entire exterior surface of the item of round produce in the wash stage.

Aspect 66: The computer-readable medium of any of Aspects 62-65, wherein the applying comprises applying the silver ion solution to the food product within two minutes after the silver ion solution is generated.

Aspect 67: A controller for controlling washing of a food product, the controller being configured to execute executable instructions to cause the controller to: control generation of a silver ion solution in a mixing stage, the generation including mixing components of the silver ion solution in the mixing stage; and control application of the silver ion solution to the food product in a wash stage, wherein the wash stage is downstream of the mixing stage.

Aspect 68: The controller of Aspect 67, wherein to control the generation of the silver ion solution, the controller is configured to execute the executable instructions to cause the controller to control the mixing of silver dihydrogen citrate, an acidulant, a polyol, and chlorine-free water in the mixing stage.

Aspect 69: The controller of Aspect 67 or 68, wherein to control the generation of the silver ion solution, the controller is configured to execute the executable instructions to cause the controller to control the generation of the silver ion solution on-demand in the mixing stage.

Aspect 70: The controller of any of Aspects 67-69, wherein the food product comprises an item of round produce and wherein to control the application of the silver ion solution, the controller is configured to execute the executable instructions to cause the controller to control the application of the silver ion solution to an entire exterior surface of the item of round produce in the wash stage.

Aspect 71: The controller of any of Aspects 67-70, wherein to control the application of the silver ion solution, the controller is configured to execute the executable instructions to cause the controller to control the application of the silver ion solution to the food product within two minutes after the silver ion solution is generated.

Aspect 72: The controller of any of Aspects 67-71, wherein the food product comprises poultry.

Aspect 73: The controller of any of Aspects 67-72, wherein the controller is configured to be the only controller in a food processing system and wherein the controller is further configured to execute the executable instructions to cause the controller to: process one or more indications received from one or more sensors in the food processing system; and send one or more control signals to one or more components of the food processing system, based on the one or more indications.

Aspect 74: A processing system comprising at least one memory storing computer-executable instructions and one or more processors coupled to the at least one memory and collectively configured to execute the computer-executable instructions and cause the processing system to perform a method in accordance with any of Aspects 17-31 or 40-49.

Aspect 75: A system comprising means for performing a method in accordance with any of Aspects 17-31 or 40-49.

Aspect 76: A non-transitory computer-readable medium comprising computer-executable instructions that, when executed by one or more processors, cause the processor(s) to perform a method in accordance with any of Aspects 17-31 or 40-49.

Aspect 77: A computer program product embodied on a computer-readable storage medium comprising code for performing a method in accordance with any of Aspects 17-31 or 40-49.

Aspect 78: An apparatus for washing a food product, the apparatus comprising: a housing; and a controller disposed in the housing and configured to execute executable instructions to cause the controller to: control generation of a silver ion solution in a wash stage, the generation including mixing components of the silver ion solution in the wash stage; and control application of the silver ion solution to the food product in the wash stage.

Aspect 79: The apparatus of Aspect 78, further comprising one or more Venturi mixers disposed in the housing, each Venturi mixer having a control input communicatively coupled to an output of the controller, wherein to control generation of the silver ion solution, the controller is further configured to execute the executable instructions to cause the controller to control the one or more Venturi mixers to control the mixing of silver dihydrogen citrate, an acidulant, a polyol, and chlorine-free water in the wash stage.

Aspect 80: The apparatus of Aspect 79, further comprising one or more pumps disposed in the housing, at least one of the pumps being fluidly coupled to one of the Venturi mixers and having a control input communicatively coupled to another output of the controller.

Aspect 81: The apparatus of Aspect 78, further comprising a pump disposed in the housing for fluidly coupling to the silver ion solution, the pump having a control input communicatively coupled to another output of the controller, wherein to control the application of the silver ion solution, the controller is configured to execute the executable instructions to cause the controller to control the pump.

Aspect 82: The apparatus of Aspect 81, wherein the controller is configured to receive an indication of a presence of the food product and to control shutting off the pump when the food product is absent.

While the present disclosure has included detail in connection with only a limited number of aspects, it should be readily understood that the present disclosure is not limited to such described aspects. Rather, the present disclosure can be modified to incorporate any number of variations, alterations, substitutions, combinations, sub-combinations, or equivalent arrangements not heretofore described, but which are commensurate with the scope of the present disclosure. Additionally, while various features of the present disclosure have been described, it is to be understood that aspects of the present disclosure may include only some of the described features.

The term “about” is intended to include the degree of error associated with measurement of the particular quantity based upon the equipment available at the time of filing the application. For example, “about” may include a range of ±8%, 5%, or 2% of a given value.

The terminology used herein is for the purpose of describing particular aspects only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to exemplary aspects, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof.

Therefore, it is intended that the present disclosure not be limited to the particular aspects described as the best mode contemplated for carrying out this present disclosure, but that the present disclosure will include all aspects falling within the scope of the claims.

1. A controller for controlling washing of a food product, the controller being configured to execute executable instructions to cause the controller to:
control generation of a silver ion solution in a wash stage, the generation including mixing components of the silver ion solution in the wash stage; and
control application of the silver ion solution to the food product in the wash stage.

2. The controller of claim 1, wherein to control the generation of the silver ion solution, the controller is configured to execute the executable instructions to cause the controller to control the mixing of silver dihydrogen citrate, an acidulant, a polyol, and chlorine-free water in the wash stage.

3. The controller of claim 1, wherein to control the generation of the silver ion solution, the controller is configured to execute the executable instructions to cause the controller to control the generation of the silver ion solution on-demand in the wash stage.

4. The controller of claim 1, wherein the food product comprises an item of round produce and wherein to control the application of the silver ion solution, the controller is configured to execute the executable instructions to cause the controller to control the application of the silver ion solution to an entire exterior surface of the item of round produce in the wash stage.

5. The controller of claim 1, wherein to control the application of the silver ion solution, the controller is configured to execute the executable instructions to cause the controller to control the application of the silver ion solution to the food product within two minutes after the silver ion solution is generated.

6. The controller of claim 1, wherein the food product comprises poultry.

7. The controller of claim 1, wherein the controller is configured to be the only controller in a food processing system and wherein the controller is further configured to execute the executable instructions to cause the controller to:
process one or more indications received from one or more sensors in the food processing system; and
send one or more control signals to one or more components of the food processing system, based on the one or more indications.

8. A method of washing a food product, the method comprising:
generating a silver ion solution in a wash stage, the generating including mixing components of the silver ion solution in the wash stage; and
applying the silver ion solution to the food product in the wash stage.

9. The method of claim 8, wherein generating the silver ion solution in the wash stage comprises mixing silver dihydrogen citrate, an acidulant, a polyol, and chlorine-free water in the wash stage.

10. The method of claim 8, wherein generating the silver ion solution comprises generating the silver ion solution on-demand in the wash stage.

11. The method of claim 8, wherein the food product comprises an item of round produce and wherein the applying comprises applying the silver ion solution to an entire exterior surface of the item of round produce in the wash stage.

12. The method of claim 8, wherein the applying comprises applying the silver ion solution to the food product within two minutes after the silver ion solution is generated.

13. A method of washing a food product, the method comprising:
generating a silver ion solution in a mixing stage, the generating comprising mixing components of the silver ion solution in the mixing stage; and
applying the silver ion solution to the food product in a wash stage, wherein the wash stage is downstream of the mixing stage.

14. The method of claim 13, wherein the applying comprises applying the silver ion solution within two minutes after the silver ion solution is generated.

15. The method of claim 13, wherein generating the silver ion solution comprises mixing silver dihydrogen citrate, an acidulant, a polyol, and chlorine-free water in the mixing stage.

16. An apparatus for washing a food product, the apparatus comprising:
a housing; and
a controller disposed in the housing and configured to execute executable instructions to cause the controller to:
control generation of a silver ion solution in a wash stage, the generation including mixing components of the silver ion solution in the wash stage; and
control application of the silver ion solution to the food product in the wash stage.

17. The apparatus of claim 16, further comprising one or more Venturi mixers disposed in the housing, each Venturi mixer having a control input communicatively coupled to an output of the controller, wherein to control generation of the silver ion solution, the controller is further configured to execute the executable instructions to cause the controller to control the one or more Venturi mixers to control the mixing of silver dihydrogen citrate, an acidulant, a polyol, and chlorine-free water in the wash stage.

18. The apparatus of claim 17, further comprising one or more pumps disposed in the housing, at least one of the pumps being fluidly coupled to one of the Venturi mixers and having a control input communicatively coupled to another output of the controller.

19. The apparatus of claim 16, further comprising a pump disposed in the housing for fluidly coupling to the silver ion solution, the pump having a control input communicatively coupled to another output of the controller, wherein to control the application of the silver ion solution, the controller is configured to execute the executable instructions to cause the controller to control the pump.

20. The apparatus of claim 19, wherein the controller is configured to receive an indication of a presence of the food product and to control shutting off the pump when the food product is absent.
